(19) United States
(12) Patent Application Publication
(10) Pub. No.: US 2026/0310474 A1
(43) Pub. Date: Oct. 8, 2026

(54) INFORMATION PROCESSING SYSTEM, INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Aichi-ken (JP)

(72) Inventors: Kei KAWASAKI, Funabashi-shi (JP); Yuki ICHIOKA, Kawasaki-shi (JP)

(21) Appl. No.: 19/632,412

(22) Filed: Mar. 30, 2026

(30) Foreign Application Priority Data
Apr. 2, 2025 (JP) 2025-061476

(51) Int. Cl. G06F 9/451; G06F 9/30

(52) U.S. Cl. CPC G06F 9/451; G06F 9/30072

(57) ABSTRACT

An information processing system for displaying, on a display, a tree image representing the structure of a behavior tree that specifies the behavior of an agent using multiple patterns corresponding to multiple nodes is configured to, in the tree image, distinguishably display a node including a conditional branch that branches control content depending on the satisfaction of a pre-set condition.

### CROSS-REFERENCE TO RELATED APPLICATION

This application claims priority to Japanese Patent Application No. 2025-061476, filed on Apr. 2, 2025, the entire contents of which are incorporated herein by reference.

### TECHNICAL FIELD

The present disclosure relates to an information processing system, an information processing apparatus, an information processing method, and a non-transitory computer readable medium.

### BACKGROUND

Behavior tree (BT) systems that represent the behavior of agents such as robots and characters in games using tree structures composed of multiple nodes are known as technology for controlling the behavior of agents. For example, see Patent Literature (PTL) 1.

### CITATION LIST

### Patent Literature

PTL 1: JP 2018-512186 A

### SUMMARY

However, conventional BT generation tools have room for improvement in terms of ease of generating BTs that represent the desired behavior of agents. That is, in recent years, there has been an increasing demand to reproduce the behavior of agents more complexly in order to improve the accuracy of simulations. When specifying such complex behavior, using conventional BT systems can lead to enormous tree structures, thus causing reduction in readability and maintainability. As a countermeasure, it is conceivable to reuse trees by expressing a sequence of behavior with a single subtree. Even with such a countermeasure, however, the tree structures inevitably become enormous when behavior involving complex logical determinations is reproduced.

It would be helpful to enable easier generation of BTs that specify desired behavior.

According to the present disclosure, an information processing system for displaying, on a display, a tree image representing the structure of a behavior tree that specifies the behavior of an agent using multiple patterns corresponding to multiple nodes,
the information processing system is configured to, in the tree image, distinguishably display a node including a conditional branch that branches control content depending on the satisfaction of a pre-set condition.

According to the present disclosure, an information processing apparatus for displaying, on a display, a tree image representing the structure of a behavior tree that specifies the behavior of an agent using multiple patterns corresponding to multiple nodes,
the information processing apparatus includes a controller configured to, in the tree image, distinguishably display a node including a conditional branch that branches control content depending on the satisfaction of a pre-set condition.

According to the present disclosure, an information processing method performed by an information processing system for displaying, on a display, a tree image representing the structure of a behavior tree that specifies the behavior of an agent using multiple patterns corresponding to multiple nodes,
the information processing method includes, in the tree image, distinguishably displaying a node including a conditional branch that branches control content depending on the satisfaction of a pre-set condition.

According to the present disclosure, an information processing program is a program configured to cause a computer to function as an information processing apparatus for displaying, on a display, a tree image representing the structure of a behavior tree that specifies the behavior of an agent using multiple patterns corresponding to multiple nodes,
the information processing apparatus configured to execute an operation including, in the tree image, distinguishably displaying a node including a conditional branch that branches control content depending on the satisfaction of a pre-set condition.

According to an embodiment of the present disclosure, it is possible to more easily generate BTs that specify desired behavior.

### BRIEF DESCRIPTION OF THE DRAWINGS

In the accompanying drawings:

FIG. 1 is a diagram illustrating an example of a configuration of an information processing system according to an embodiment of the present disclosure;

FIG. 2 is a block diagram illustrating an example of a hardware configuration of an information processing apparatus of FIG. 1;

FIG. 3 is a block diagram illustrating an example of a hardware configuration of a terminal apparatus of FIG. 1;

FIG. 4 is a block diagram illustrating an example of a functional configuration of the information processing system of FIG. 1;

FIG. 5 is a diagram illustrating an example of a BT according to the present embodiment;

FIG. 6 is a diagram illustrating an example of a node of FIG. 5;

FIG. 7 is a diagram illustrating a BT according to a comparative example;

FIG. 8 is a diagram illustrating a BT according to another comparative example;

FIG. 9 is a diagram illustrating an example of a screen displayed on the terminal apparatus;

FIG. 10 is a diagram illustrating an example of a tree image illustrating the structure of the BT;

FIG. 11 is a diagram illustrating an example of an image illustrating a node of FIG. 10;

FIG. 12 is a diagram illustrating an example of an image for settings of the BT and the attributes of nodes;

FIG. 13 is a diagram illustrating an example of an image for settings of a conditional branch in a node; and

FIG. 14 is a flowchart illustrating an example of operations of the information processing system.

### DETAILED DESCRIPTION

An embodiment of the present disclosure will be described below, with reference to the drawings. In the drawings, portions having the same configuration or function are denoted by the same reference numeral. In the description of the present embodiment, duplicate descriptions of the same portions are in some cases omitted or simplified, as appropriate.

### Information Processing System 1

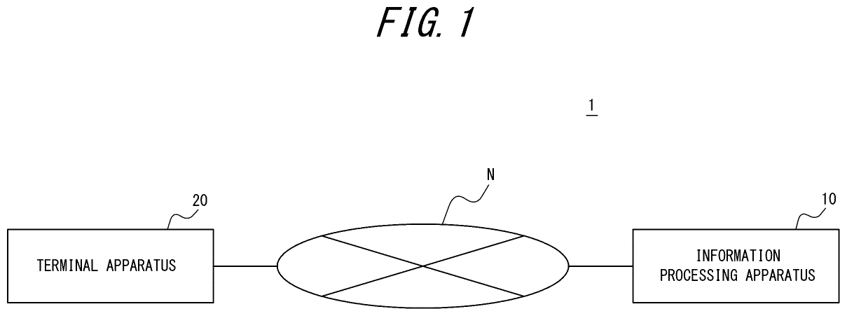

FIG. 1 is a diagram illustrating an example of a configuration of an information processing system 1 according to the embodiment of the present disclosure. The information processing system 1 assists in generating a behavior tree (BT) describing the behavior of an agent. As illustrated in FIG. 1, the information processing system 1 includes an information processing apparatus 10 and a terminal apparatus 20. The information processing apparatus 10 and the terminal apparatus 20 can communicate with each other via a network N.

The information processing apparatus 10 is a computer that assists in generating a BT in response to user instructions via the terminal apparatus 20. The information processing apparatus 10 may be, for example, a server apparatus installed in a data center or the like, or a server apparatus belonging to a cloud computing system or other computing systems.

The terminal apparatus 20 is a computer operated by a user. The terminal apparatus 20 accepts instructions from the user and outputs, to the user, the processing results of the information processing apparatus 10 and the terminal apparatus 20 in response to the instructions. The terminal apparatus 20 may access the information processing apparatus 10 via, for example, a web browser or dedicated application software. The terminal apparatus 20 may be, for example, a general purpose electronic device such as a personal computer (PC), smartphone, tablet terminal, or wearable terminal, or a dedicated electronic device.

The network N is any communication medium such as the Internet, intranet, and mobile communication networks. The information processing apparatus 10 and the terminal apparatus 20 are communicably connected via the network N.

FIG. 1 illustrates one information processing apparatus 10 and one terminal apparatus 20, but the information processing system 1 may include multiple units of these apparatuses. In the present embodiment, the user accesses the information processing apparatus 10 via the terminal apparatus 20, but the present embodiment is not limited to this configuration. For example, the information processing apparatus 10 and the terminal apparatus 20 may be realized by the same computer such as a PC.

In the information processing system 1, the user generates a BT that specifies the behavior of an agent by operating the terminal apparatus 20. The information processing system 1 displays, on a display (output interface 25) of the terminal apparatus 20, a tree image that represents the structure of the BT using multiple patterns corresponding to multiple nodes. Here, the information processing system 1 distinguishably displays, in the tree image, nodes each including a conditional branch that branches control content depending on the satisfaction of a pre-set condition.

As described above, the information processing system 1 can define conditional branches, each of which branches control content depending on the satisfaction of a pre-set condition, within the nodes, thus preventing the BT from being enormous due to conditional branches and leading to effects such as reduced processing load and reduced memory usage. The information processing system 1 can also improve the readability and maintainability of the system by distinguishably displaying the nodes including the conditional branches. Therefore, the information processing system 1 can more easily generate BTs that specify desired behavior.

### Example of Hardware Configuration of Information Processing Apparatus 10

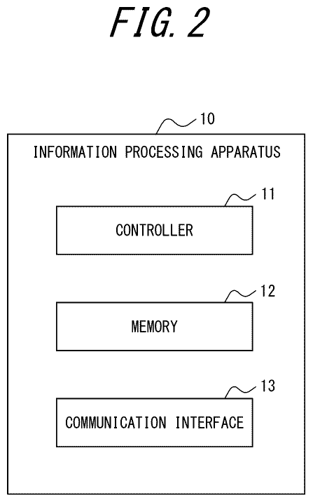

FIG. 2 is a block diagram illustrating an example of a hardware configuration of the information processing apparatus 10 of FIG. 1. As illustrated in FIG. 2, the information processing apparatus 10 includes a controller 11, a memory 12, and a communication interface 13.

The controller 11 includes at least one processor. In one embodiment, the “processor” is a general purpose processor or a dedicated processor specialized for specific processing, but is not limited to these. The controller 11 is communicably connected to each component included in the information processing apparatus 10 and controls operations of the entire information processing apparatus 10.

The memory 12 includes any memory module such as a hard disk drive (HDD), a solid state drive (SSD), read-only memory (ROM), and random access memory (RAM). The memory 12 may function as, for example, a main memory, an auxiliary memory, or a cache memory. The memory 12 stores any information to be used for operations of the information processing apparatus 10. For example, the memory 12 may store a system program, an application program, various types of information received by the communication interface 13, and the like. The memory 12 is not limited to being built into the information processing apparatus 10, and may also be an external database or an external memory module. The memory 12 may be provided as network storage connected to the network N.

The memory 12 may store a trained model that has been pre-trained, when a prompt (for example, natural language or a figure) is input, to output a BT modified according to the content of the prompt. The trained model is a model generated by machine learning using a machine learning algorithm. The trained model may be, for example, a machine learning model constructed based on a decision tree, or a model generated based on a machine learning algorithm such as convolutional neural network (CNN), recurrent neural network (RNN), or other deep learning techniques.

The trained model may include a language model that includes any dialogue system such as a large language model (LLM) or a chatbot. When a prompt, i.e., user instruction is input, the language model outputs text or a figure corresponding to the prompt. For example, the information processing apparatus 10 may input a prompt into the language model, and acquire the output result of a BT corresponding to the prompt.

The communication interface 13 includes any communication module capable of communicating with other apparatuses using any communication technology. The communication interface 13 may further include a communication control module for controlling communication with other apparatuses, and a memory module for storing communication data such as identification information necessary for communication with other apparatuses.

The functions of the information processing apparatus 10 may be realized by executing a computer program (program) according to the present embodiment on a processor included in the controller 11. That is, the functions of the information processing apparatus 10 are realized by software. The computer program causes a computer to execute the processes of steps included in operations of the information processing apparatus 10, thereby enabling the computer to realize functions corresponding to the processes of the steps. That is, the computer program is a program for causing the computer to function as the information processing apparatus 10 according to the present embodiment.

The computer program can be recorded on a computer readable recording medium. The computer readable recording medium is, for example, a magnetic recording device, an optical disc, a magneto-optical recording medium, or a semiconductor memory. The program is distributed, for example, by selling, transferring, or lending a portable recording medium such as a digital versatile disc (DVD) or a universal serial bus (USB) memory on which the program is recorded. The program may be distributed by storing the program in the storage of a server and transferring the program from the server to another computer via a network. The program may also be provided as a program product.

For example, the computer may temporarily store, in the main memory, the program recorded on the portable recording medium or the program transferred from the server. Then, the computer may read the program stored in the main memory using the processor, and execute processes in accordance with the read program using the processor. The computer may read the program directly from the portable recording medium, and execute processes in accordance with the program. The computer may, each time a program is transferred from the server to the computer, sequentially execute processes in accordance with the received program. Such processing may be executed by a so-called ASP type service that realizes functions merely by execution instructions and result acquisitions, without transferring the program from the server to the computer. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 10 may be realized by a dedicated circuit included in the controller 11. That is, some or all of the functions of the information processing apparatus 10 may be realized by hardware. The information processing apparatus 10 may be realized by a single computer or by the collaboration of multiple computers.

### Example of Hardware Configuration of Terminal Apparatus 20

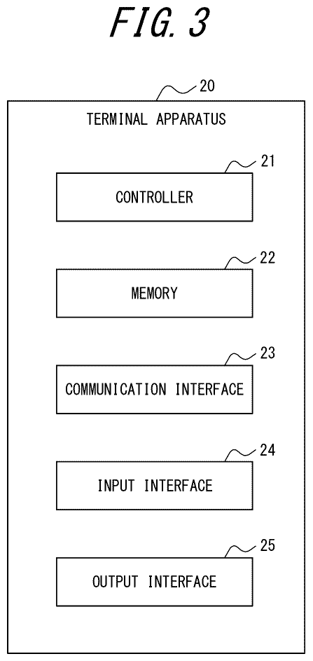

FIG. 3 is a block diagram illustrating an example of a hardware configuration of the terminal apparatus 20 of FIG. 1. The terminal apparatus 20 includes a controller 21, a memory 22, a communication interface 23, an input interface 24, and an output interface 25. The functions and configurations of the controller 21, memory 22, and communication interface 23 of the terminal apparatus 20 are similar to those of the controller 11, memory 12, and communication interface 13 of the information processing apparatus 10, so detailed explanations thereof are omitted.

The input interface 24 includes at least one input interface for accepting user input operations and acquiring input information based on the user input operations. For example, the input interface 24 includes a physical key, a capacitive key, a pointing device, a touch screen integrally provided with a display of the output interface 25, a microphone that accepts audio input, or the like, but is not limited to these.

The output interface 25 includes at least one output interface for outputting information to a user and notifying the user. For example, the output interface 25 includes a display for outputting information as images, a speaker for outputting information as audio, or the like, but is not limited to these. Such a display may be, for example, a liquid crystal panel display or an organic electro luminescent (EL) display. The above-described input interface 24 and/or output interface 25 may be configured integrally with the terminal apparatus 20 or may be provided separately.

As with the information processing apparatus 10, the functions of the terminal apparatus 20 may be realized by software or by hardware. The terminal apparatus 20 may be realized by a single computer or by the collaboration of multiple computers that can communicate with each other.

### Example of Functional Configuration of Information Processing System 1

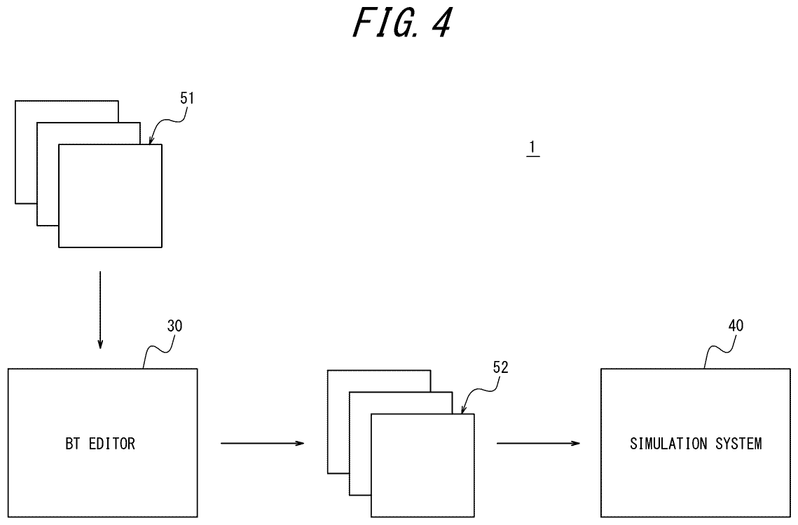

FIG. 4 is a block diagram illustrating an example of a functional configuration of the information processing system 1 of FIG. 1. The information processing system 1 includes a BT editor 30 and a simulation system 40. These functional elements may be realized by the information processing apparatus 10 and/or the terminal apparatus 20 operating based on a program. The simulation system 40 may be realized by a computer other than the information processing apparatus 10 and the terminal apparatus 20.

The BT generator 30 generates a BT based on user instructions, displays the tree structure of the BT to accept a modification, and displays an image reproducing an operation of an agent represented by the BT. The agent may be, for example, a robot, a character in a game, or the like. The BT represents the behavior of the agent through the tree structure that includes multiple nodes (root, control flow, execution, and the like) and edges. The BT editor 30 may load a library 51 such as subtrees of the BT in response to the user instructions.

The BT editor 30 outputs the generated BT as agent data 52 to the simulation system 40. The agent data 52 is binary data in a specific format that can be read by the simulation system 40.

The simulation system 40 reads the agent data 52 output from the BT editor 30, and simulates the operation of the agent represented by the agent data 52.

The simulation system 40 reads multiple pieces of agent data 52 and simulates operations of multiple agents. Therefore, setting up and starting the simulation system 40 often require time and effort. In the simulation system 40, operations of agents other than an agent of interest are also simulated. Accordingly, using the simulation system 40 to tune the behavior of a specific agent may be inefficient for adjusting the behavior of the agent of interest.

Therefore, the BT editor 30 may generate a preview image that reproduces the operation of the agent based on the generated BT and display the preview image. Thus, the BT editor 30 may have the function of reproducing the operation of the agent specified by the BT, without executing a simulation by the simulation system 40, which would take time and effort. With such a configuration, a user can easily check whether the generated BT meets desired requirements by checking the preview image.

The user can easily modify the BT through an operation on an image visually representing the structure of the BT in the BT editor 30, or through input of a prompt in natural language or the like. The BT editor 30 generates and displays a preview image in response to a modification to the BT. As a result, the user can immediately confirm the modification result of the BT, and therefore can efficiently tune the operation of the agent until a desired operation is achieved, through repeated modifications and confirmations of the BT.

Upon obtaining a BT that specifies the desired operation, the user approves the BT. In response, the BT editor 30 outputs agent data 52, which can be executed by the simulation system 40, based on the generated BT.

Upon obtaining a user approval to the BT, the BT editor 30 may register the BT as a library. This allows the user to call up the library and reuse the BT, thereby improving the efficiency of the entire process.

### Example of Operations

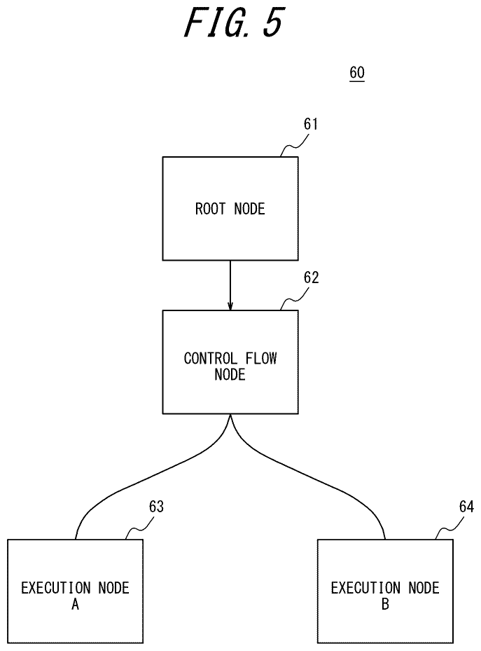

FIG. 5 is a diagram illustrating an example of a BT 60 according to the present embodiment. The BT 60 illustrated in FIG. 5 includes four nodes 61 to 64. The node 61 is a root node. The node 62 is a control flow node. The node 63 is an execution node A. The node 64 is an execution node B.

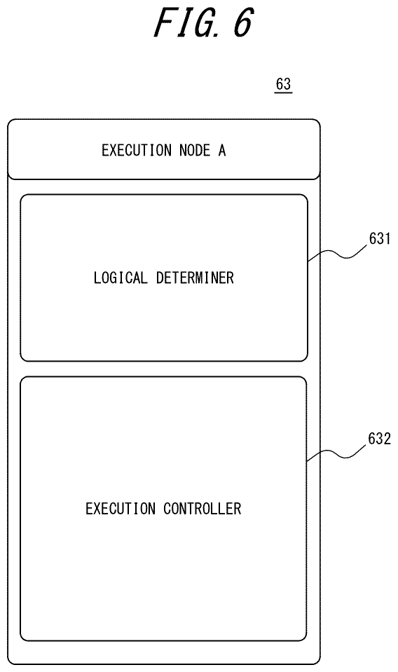

FIG. 6 is a diagram illustrating an example of the node 63 (execution node A) in FIG. 5. As illustrated in FIG. 6, the node 63 includes not only an execution controller 632 that specifies the control content of an agent but also a logical determiner 631 that specifies logical determination. The logical determiner 631 may express multiple conditions in the form of a combination of AND conditions and/or OR conditions, and specify an operation depending on a conditional branch.

For example, the logical determiner 631 may specify an operation performed when both a first condition and a second condition are satisfied, as an operation performed when “first condition (AND) second condition” is true. The logical determiner 631 may specify an operation performed when the first condition and/or the second condition is satisfied, as an operation performed when “first condition (OR) second condition” is true. Furthermore, the logical determiner 631 may specify the first condition and/or the second condition, as a combination of conditions using AND conditions and/or OR conditions. For example, the logical determiner 631 may specify an operation performed when “(third condition (OR) fourth condition) (AND) (fifth condition (OR) sixth condition)” is true.

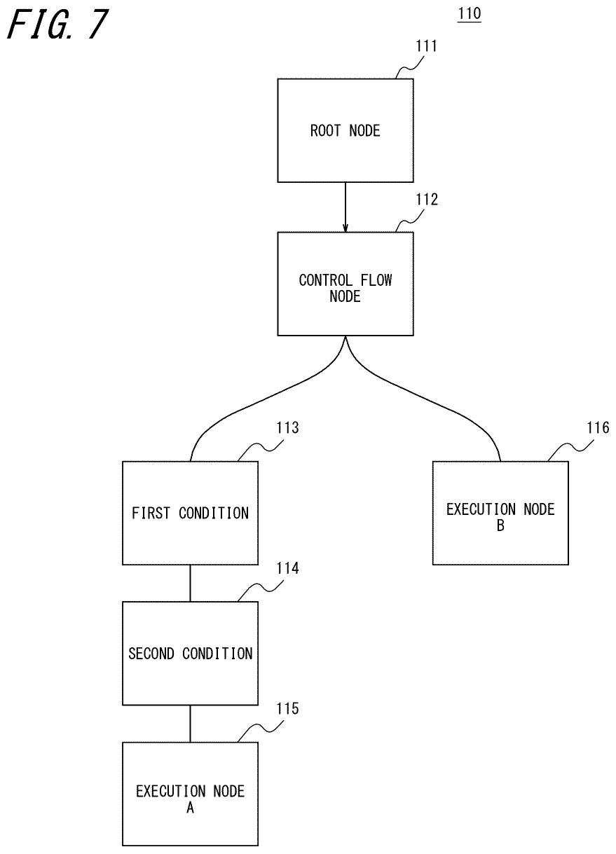

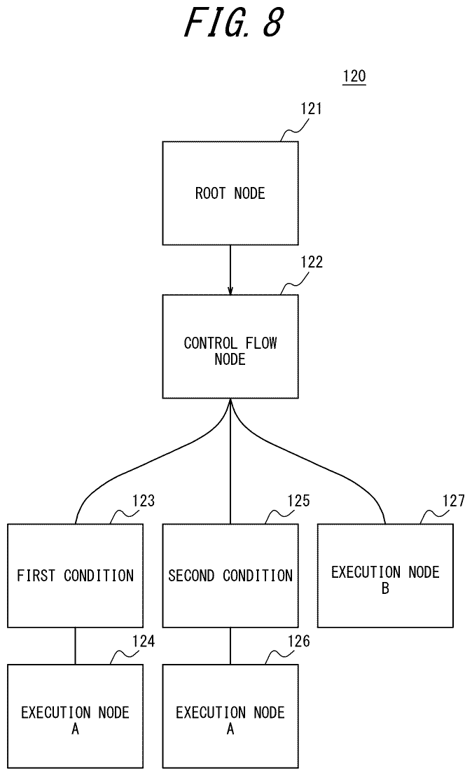

FIGS. 7 and 8 are diagrams illustrating BTs 110 and 120 according to comparative examples. The BTs 110 and 120 in FIGS. 7 and 8 include only an execution controller 632 at each node, and do not include a logical determiner 631.

The BT 110 of FIG. 7 includes six nodes 111 to 116. The node 111 is a root node. The node 112 is a control flow node. The nodes 113 and 114 are condition nodes. The node 115 is an execution node A. The node 116 is an execution node B. As illustrated in FIG. 7, in the BT 110, the nodes 113 to 115 need to be connected in series, in order to specify that execution control of the execution node A (node 115) is executed when both a first condition and a second condition are satisfied. In contrast, in the present embodiment, as illustrated in FIG. 6, the logical determiner 631 of the node 63 can specify, using an AND condition, that the execution control is executed when both the first condition and the second condition are satisfied. Therefore, the same logic as in FIG. 7 can be specified in a simplified tree structure as in FIG. 5.

The BT 120 of FIG. 8 includes seven nodes 121 to 127. The node 121 is a root node. The node 122 is a control flow node. The nodes 123 and 125 are condition nodes. The nodes 124 and 126 are execution nodes A. The node 127 is an execution node B. As illustrated in FIG. 8, in the BT 120, the nodes 123 to 126 need to be specified, in order to specify that execution control of the execution node A is executed when a first condition and/or a second condition is satisfied. In contrast, in the present embodiment, as illustrated in FIG. 6, the logical determiner 631 of the node 63 can specify, using an OR condition, that the execution control is executed when the first condition and/or the second condition is satisfied. Therefore, the same logic as in FIG. 8 can be specified in a simplified tree structure as in FIG. 5.

As described above, the information processing system 1 according to the present embodiment enables logical determination at each of the nodes 61 to 64 by adding the logical determiner 631, which is a functional block for logical determination, to each of the nodes 61 to 64, while having the functions of a general purpose BT system. As a result, BTs are simplified, and the readability and maintainability of the BTs are improved. Simplifying the BTs allows reduction in the number of nodes processed on a BT screen. Furthermore, the reduction in the number of nodes may lead to reduced processing load and reduced memory usage during operation.

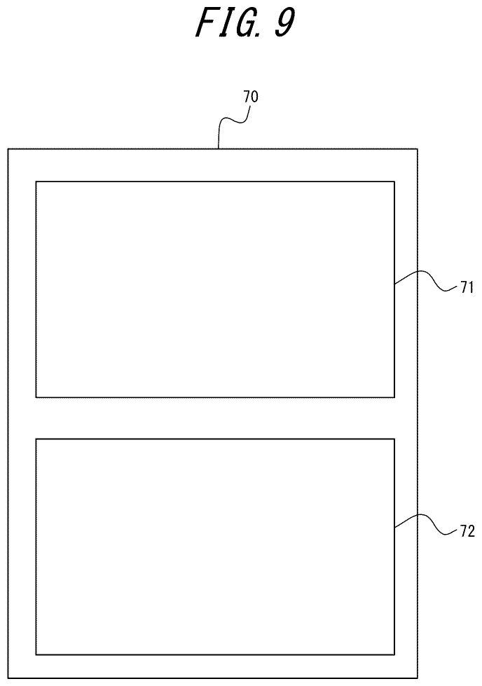

FIG. 9 is a diagram illustrating an example of a screen displayed on the terminal apparatus 20. An image 70 includes a tree image 71 and an image 72.

The tree image 71 visually represents the structure of a BT generated in response to user instructions, and accepts a modification to the BT. The image 72 accepts detailed settings for the BT and for attribute values and the like of nodes and edges constituting the BT.

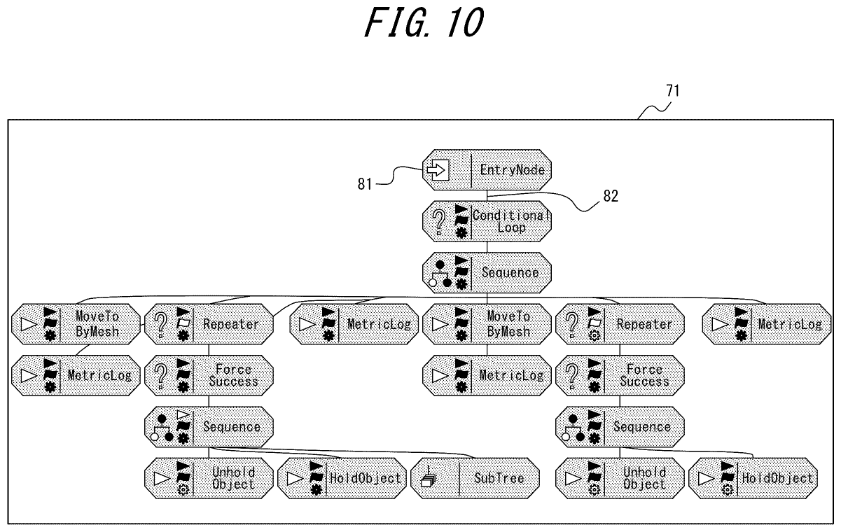

FIG. 10 is a diagram illustrating an example of the tree image 71 representing the structure of the BT. The tree image 71 includes multiple node images 81 and multiple edge images 82 connecting the nodes. For example, the terminal apparatus 20 may allow a user to modify the BT through an operation on a node image 81. For example, the terminal apparatus 20 may accept addition or deletion of a node or edge, a change to the attribute, type, or the like of a node or edge, or the like through a selection operation, a drag operation, or the like on a node image 81 or edge image 82.

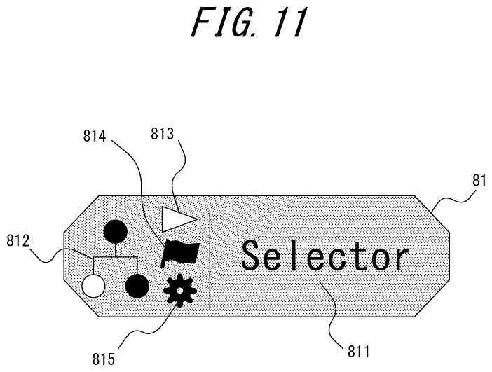

FIG. 11 is a diagram illustrating an example of a node image 81 in FIG. 10. The node image 81 includes images 811 to 815. The image 811 indicates the function of the node by displaying a term such as “EntryNode,” “ConditionalLoop,” “Sequence,” or “MoveToByMesh.” The image 812 indicates the meaning of the node by a pattern thereof. The image 813, as a first indication, indicates whether the node includes a conditional branch that branches control content depending on the satisfaction of a pre-set condition, based on specifications in the logical determiner 631 and the like in FIG. 6. The image 814, as a second indication, indicates whether the control content indicated by the node can be forcibly terminated during operation. The image 815, as a third indication, indicates whether a setting value related to the control content indicated by the node can be changed.

In the examples of FIG. 10 and FIG. 11, the images 813 to 815 specify the presence or absence of these functions by black or white display of the patterns, but the first to third indications may distinguish the presence or absence of these functions by any display. For example, when these functions are present, the patterns or background colors thereof may be changed, or another pattern such as a star mark may be superimposed. As described above, the information processing system 1 indicates the presence or absence of these functions through the images 813 to 815, thus allowing the user to easily recognize content specified by the BT.

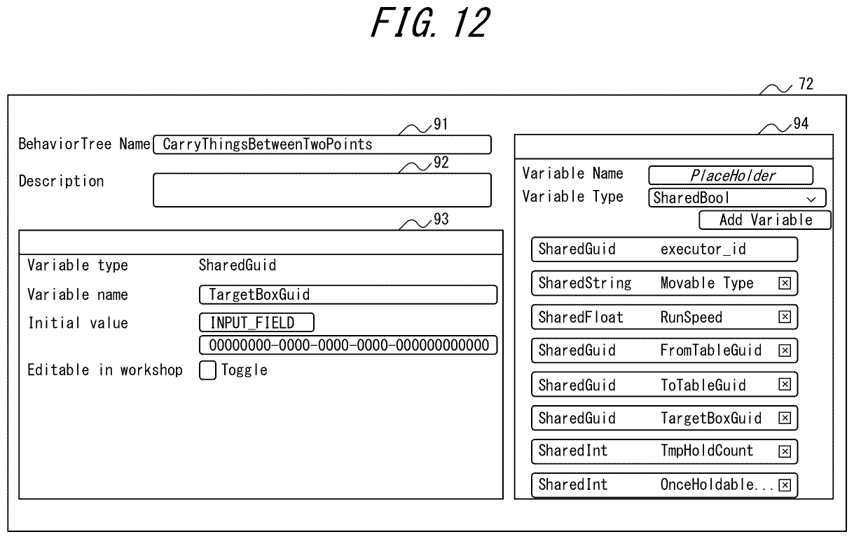

FIG. 12 is a diagram illustrating an example of the image 72 for settings of the BT and the attributes of nodes. An image 91 displays the name of the BT. An image 92 indicates a functional description of the BT. Images 93 and 94 accept the settings, changes, and the like of the variable type, variable name, initial value, editability, and the like of a selected node. By performing necessary settings in the image 72, the user can make detailed definitions of the BT.

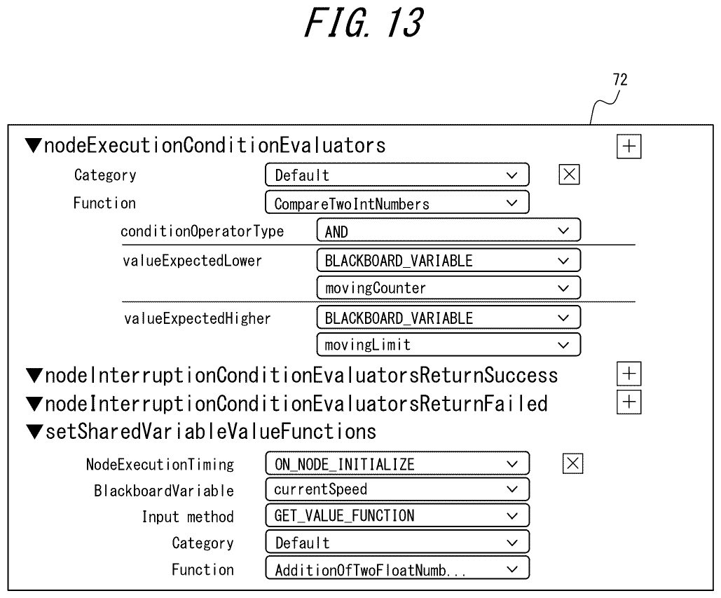

FIG. 13 is a diagram illustrating an example of an image for settings of a conditional branch in a node. The user can detail the conditional branch in the logic determiner 631 of that node by selecting “AND” or “OR” in “conditionOperatorType.”

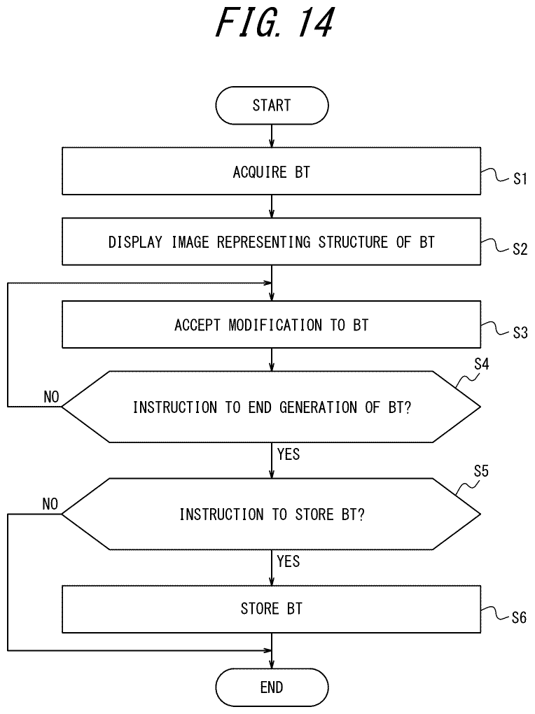

FIG. 14 is a flowchart illustrating an example of operations of the information processing system 1. The operations of the information processing system 1 described with reference to FIG. 14 may correspond to one of information processing methods. The operation of each step in FIG. 14 may be executed based on control by the controller 11 of the information processing apparatus 10 and/or the controller 21 of the terminal apparatus 20.

In S1, the controller 11 acquires a BT. For example, the controller 11 may read and acquire, from the memory 12, a BT generated in response to user instructions.

In S2, the controller 11 displays a tree image 71, which represents the structure of the BT acquired in S1, on a display (the output interface 25 of the terminal apparatus 20). As illustrated in FIG. 10, the controller 11 distinguishably displays, in the tree image 71, nodes each including a conditional branch that branches control content depending on the satisfaction of a pre-set condition.

In S3, the controller 11 accepts a modification to the BT from a user. For example, the controller 11 may accept a modification to the BT through an operation on the image 71 or 72 included in an image 70.

In S4, the controller 11 determines whether there is an instruction to end the generation of the BT from the user. When there is an instruction to end the generation of the BT (YES in S4), the controller 11 proceeds to S5. Otherwise (NO in S4), the controller 11 returns to S3.

In S5, the controller 11 determines whether there is an instruction to store the generated BT. For example, when the end of the generation of the BT is instructed, a screen asking the user whether to store the BT may be displayed to accept an instruction to store the BT. When there is an instruction to store the BT (YES in S5), the controller 11 proceeds to S6. Otherwise (NO in S5), the controller 11 ends processing of the flowchart.

In S6, the controller 11 stores the generated BT in the memory 12. The controller 11 then ends the processing of the flowchart.

As described above, the information processing system 1 displays, on a display (for example, the output interface 25 of the terminal apparatus 20), a tree image 71 that represents the structure of a BT, which specifies the behavior of an agent, using multiple patterns corresponding to multiple nodes. The information processing system 1 distinguishably displays, in the tree image 71, nodes each including a conditional branch that branches control content depending on the satisfaction of a pre-set condition.

Thus, the information processing system 1 can define conditional branches, each of which branches control content depending on the satisfaction of a pre-set condition, within the nodes, thus preventing the BT from being enormous due to conditional branches and leading to effects such as reduced processing load and reduced memory usage. The information processing system 1 can also improve the readability and maintainability of the system by distinguishably displaying the nodes including the conditional branches. Therefore, the information processing system 1 can more easily generate BTs that specify desired behavior.

The pre-set condition may include a condition defined using an AND condition and/or an OR condition. With such a configuration, it is possible to specify complex conditions using AND conditions and OR conditions.

In the tree image 71, a first indication (for example, image 813) indicating whether each node includes a conditional branch may be appended to each of the multiple patterns. With such a configuration, a user can confirm the presence or absence of a conditional branch at each node on a UI screen.

In the tree image 71, a second indication (for example, the image 814) indicating whether control content indicated by each node can be forcibly terminated during operation may be appended to each of the multiple patterns. With such a configuration, the user can confirm on the UI screen whether forced termination during operation is possible for each node.

In the tree image 71, a third indication (for example, image 815) indicating whether a setting value related to control content indicated by each node can be changed may be appended to each of the multiple patterns. With such a configuration, the user can confirm the changeability of the setting value for each node on the UI screen.

The present disclosure is not limited to the embodiment described above. For example, a plurality of blocks described in the block diagram may be integrated, or a single block may be divided. Instead of executing a plurality of steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these.

[Appendix 1] An information processing system for displaying, on a display, a tree image representing a structure of a behavior tree that specifies behavior of an agent using multiple patterns corresponding to multiple nodes,
the information processing system configured to, in the tree image, distinguishably display a node including a conditional branch that branches control content depending on satisfaction of a pre-set condition.

[Appendix 2] The information processing system according to appendix 1, wherein the pre-set condition includes a condition defined using an AND condition and/or an OR condition.

[Appendix 3] The information processing system according to appendix 1 or 2, wherein in the tree image, a first indication indicating whether each node includes a conditional branch is appended to each of the multiple patterns.

[Appendix 4] The information processing system according to any one of appendices 1 to 3, wherein in the tree image, a second indication indicating whether control content indicated by each node can be forcibly terminated during operation is appended to each of the multiple patterns.

[Appendix 5] The information processing system according to any one of appendices 1 to 4, wherein in the tree image, a third indication indicating whether a setting value related to control content indicated by each node can be changed is appended to each of the multiple patterns.

[Appendix 6] An information processing apparatus for displaying, on a display, a tree image representing a structure of a behavior tree that specifies behavior of an agent using multiple patterns corresponding to multiple nodes,
the information processing apparatus comprising a controller configured to, in the tree image, distinguishably display a node including a conditional branch that branches control content depending on satisfaction of a pre-set condition.

[Appendix 7] The information processing apparatus according to appendix 6, wherein the pre-set condition includes a condition defined using an AND condition and/or an OR condition.

[Appendix 8] The information processing apparatus according to appendix 6 or 7, wherein in the tree image, a first indication indicating whether each node includes a conditional branch is appended to each of the multiple patterns.

[Appendix 9] The information processing apparatus according to any one of appendices 6 to 8, wherein in the tree image, a second indication indicating whether control content indicated by each node can be forcibly terminated during operation is appended to each of the multiple patterns.

[Appendix 10] The information processing apparatus according to any one of appendices 6 to 9, wherein in the tree image, a third indication indicating whether a setting value related to control content indicated by each node can be changed is appended to each of the multiple patterns.

[Appendix 11] An information processing method performed by an information processing system for displaying, on a display, a tree image representing a structure of a behavior tree that specifies behavior of an agent using multiple patterns corresponding to multiple nodes,
the information processing method comprising, in the tree image, distinguishably displaying a node including a conditional branch that branches control content depending on satisfaction of a pre-set condition.

[Appendix 12] The information processing method according to appendix 11, wherein the pre-set condition includes a condition defined using an AND condition and/or an OR condition.

[Appendix 13] The information processing method according to appendix 11 or 12, wherein in the tree image, a first indication indicating whether each node includes a conditional branch is appended to each of the multiple patterns.

[Appendix 14] The information processing method according to any one of appendices 11 to 13, wherein in the tree image, a second indication indicating whether control content indicated by each node can be forcibly terminated during operation is appended to each of the multiple patterns.

[Appendix 15] The information processing method according to any one of appendices 11 to 14, wherein in the tree image, a third indication indicating whether a setting value related to control content indicated by each node can be changed is appended to each of the multiple patterns.

[Appendix 16] A program configured to cause a computer to function as an information processing apparatus for displaying, on a display, a tree image representing a structure of a behavior tree that specifies behavior of an agent using multiple patterns corresponding to multiple nodes,
the information processing apparatus configured to execute an operation comprising, in the tree image, distinguishably displaying a node including a conditional branch that branches control content depending on satisfaction of a pre-set condition.

[Appendix 17] The program according to appendix 16, wherein the pre-set condition includes a condition defined using an AND condition and/or an OR condition.

[Appendix 18] The program according to appendix 16 or 17, wherein in the tree image, a first indication indicating whether each node includes a conditional branch is appended to each of the multiple patterns.

[Appendix 19] The program according to any one of appendices 16 to 18, wherein in the tree image, a second indication indicating whether control content indicated by each node can be forcibly terminated during operation is appended to each of the multiple patterns.

[Appendix 20] The program according to any one of appendices 16 to 19, wherein in the tree image, a third indication indicating whether a setting value related to control content indicated by each node can be changed is appended to each of the multiple patterns.

1. An information processing system for displaying, on a display, a tree image representing a structure of a behavior tree that specifies behavior of an agent using multiple patterns corresponding to multiple nodes,
the information processing system configured to, in the tree image, distinguishably display a node including a conditional branch that branches control content depending on satisfaction of a pre-set condition.

2. The information processing system according to claim 1, wherein the pre-set condition includes a condition defined using an AND condition and/or an OR condition.

3. The information processing system according to claim 1, wherein in the tree image, a first indication indicating whether each node includes a conditional branch is appended to each of the multiple patterns.

4. The information processing system according to claim 1, wherein in the tree image, a second indication indicating whether control content indicated by each node can be forcibly terminated during operation is appended to each of the multiple patterns.

5. The information processing system according to claim 1, wherein in the tree image, a third indication indicating whether a setting value related to control content indicated by each node can be changed is appended to each of the multiple patterns.

6. An information processing apparatus for displaying, on a display, a tree image representing a structure of a behavior tree that specifies behavior of an agent using multiple patterns corresponding to multiple nodes,
the information processing apparatus comprising a controller configured to, in the tree image, distinguishably display a node including a conditional branch that branches control content depending on satisfaction of a pre-set condition.

7. The information processing apparatus according to claim 6, wherein the pre-set condition includes a condition defined using an AND condition and/or an OR condition.

8. The information processing apparatus according to claim 6, wherein in the tree image, a first indication indicating whether each node includes a conditional branch is appended to each of the multiple patterns.

9. The information processing apparatus according to claim 6, wherein in the tree image, a second indication indicating whether control content indicated by each node can be forcibly terminated during operation is appended to each of the multiple patterns.

10. The information processing apparatus according to claim 6, wherein in the tree image, a third indication indicating whether a setting value related to control content indicated by each node can be changed is appended to each of the multiple patterns.

11. An information processing method performed by an information processing system for displaying, on a display, a tree image representing a structure of a behavior tree that specifies behavior of an agent using multiple patterns corresponding to multiple nodes,
the information processing method comprising, in the tree image, distinguishably displaying a node including a conditional branch that branches control content depending on satisfaction of a pre-set condition.

12. The information processing method according to claim 11, wherein the pre-set condition includes a condition defined using an AND condition and/or an OR condition.

13. The information processing method according to claim 11, wherein in the tree image, a first indication indicating whether each node includes a conditional branch is appended to each of the multiple patterns.

14. The information processing method according to claim 11, wherein in the tree image, a second indication indicating whether control content indicated by each node can be forcibly terminated during operation is appended to each of the multiple patterns.

15. The information processing method according to claim 11, wherein in the tree image, a third indication indicating whether a setting value related to control content indicated by each node can be changed is appended to each of the multiple patterns.

16. A non-transitory computer readable medium storing a program configured to cause a computer to function as an information processing apparatus for displaying, on a display, a tree image representing a structure of a behavior tree that specifies behavior of an agent using multiple patterns corresponding to multiple nodes,
the information processing apparatus configured to execute an operation comprising, in the tree image, distinguishably displaying a node including a conditional branch that branches control content depending on satisfaction of a pre-set condition.

17. The non-transitory computer readable medium according to claim 16, wherein the pre-set condition includes a condition defined using an AND condition and/or an OR condition.

18. The non-transitory computer readable medium according to claim 16, wherein in the tree image, a first indication indicating whether each node includes a conditional branch is appended to each of the multiple patterns.

19. The non-transitory computer readable medium according to claim 16, wherein in the tree image, a second indication indicating whether control content indicated by each node can be forcibly terminated during operation is appended to each of the multiple patterns.

20. The non-transitory computer readable medium according to claim 16, wherein in the tree image, a third indication indicating whether a setting value related to control content indicated by each node can be changed is appended to each of the multiple patterns.
